(19) United States
(12) Patent Application Publication
(10) Pub. No.: US 2013/0255447 A1
(43) Pub. Date: Oct. 3, 2013

(54) Automated Screw Driving Device

(71) Applicant: BASSO INDUSTRY CORP., Taichung (TW)

(72) Inventor: Chien-Kuo Po, Taichung (TW)

(73) Assignee: BASSO INDUSTRY CORP., Taichung (TW)

(21) Appl. No.: 13/846,881

(22) Filed: Mar. 18, 2013

(30) Foreign Application Priority Data
Mar. 30, 2012 (TW) 101111476

(51) Int. Cl. B25B 21/00

(52) U.S. Cl. CPC B25B 21/00
USPC 81/57.11

(57) ABSTRACT

An automated screw driving device comprises: a gun housing; a first motor mounted to the gun housing; a fly wheel mounted to the gun housing and driven by the first motor to rotate relative to the gun housing; a carrier mounted slidably on the gun housing and having a wheel-contacting member that is movable toward the fly wheel to contact the fly wheel so as to permit the power of the first motor to be transferred to the carrier to cause rapid sliding movement of the carrier upon rotation of the fly wheel about its axis; a screw driver mounted rotatably to the carrier; a gear set coupled to the screw driver; and a second motor coupled to the gear set for driving rotation of the screw driver relative to the carrier.

### CROSS-REFERENCE TO RELATED APPLICATION

This application claims priority of Taiwanese Application No. 101111476, filed on Mar. 30, 2012.

### BACKGROUND OF THE INVENTION

1. Field of the Invention

This invention relates to an automated screw driving device, more particularly to an automated screw driving device that has a screw driver driven by a fly wheel to hit a screw for driving the screw into an object.

2. Description of the Related Art

Referring to FIG. 1, U.S. Pat. No. 5,890,405 illustrates a conventional automated screw driving device 1 that includes a gun housing 10, a screw driver 11 mounted in the gun housing 10 and extending along an axial direction, a rack 12 connected to the screw driver 11, a first motor 131, a pinion 121 engaging the rack 12, a first gear set 132 coupled to the first motor 131 and engaging the pinion 121, a second motor 141, a second gear set 143 coupled to the second motor 141, a sleeve 142 sleeved on the screw driver 11 and connected to the second gear set 143, and a screw magazine 16 for feeding a screw 15 into a screw passage in the gun housing 10. In operation, the first motor 131 is actuated so as to drive the rack 12 together with the screw driver 11 to move gradually in the axial direction through rotation of the pinion 121, and the second motor 141 is subsequently actuated to drive rotation of the screw driver 11 about its axis through the second gear set 143, thereby driving the screw 15 into an object (not shown).

The Applicant found that the operation of moving the screw 15 to the object and penetrating a sharp tapered end portion of the screw 15 into the object takes too much time due to the use of the rack 12 and the pinion 121 as a means to transfer the power of the first motor 131 to the screw driver 11.

### SUMMARY OF THE INVENTION

Therefore, the object of the present invention is to provide an automated screw driving device that can overcome the aforesaid drawback associated with the prior art.

According to this invention, there is provided an automated screw driving device that comprises: a gun housing defining a screw passage that is adapted to receive a screw therein; a first motor mounted to the gun housing; a fly wheel mounted to the gun housing and driven by the first motor to rotate relative to the gun housing about its axis; a carrier mounted slidably on the gun housing and having a wheel-contacting member that is movable toward the fly wheel to contact frictionally the fly wheel so as to permit the power of the first motor to be transferred to the carrier to cause rapid sliding movement of the carrier relative to the gun housing toward the screw passage upon rotation of the fly wheel about its axis; a screw driver mounted rotatably to the carrier so as to be carried by the carrier to hit the screw in the screw passage upon rapid sliding movement of the carrier; a gear set coupled to the screw driver; and a second motor coupled to the gear set for driving rotation of the screw driver relative to the carrier.

### BRIEF DESCRIPTION OF THE DRAWINGS

In drawings which illustrate an embodiment of the invention,

FIG. 1 is a schematic view of a conventional automated screw driving device;

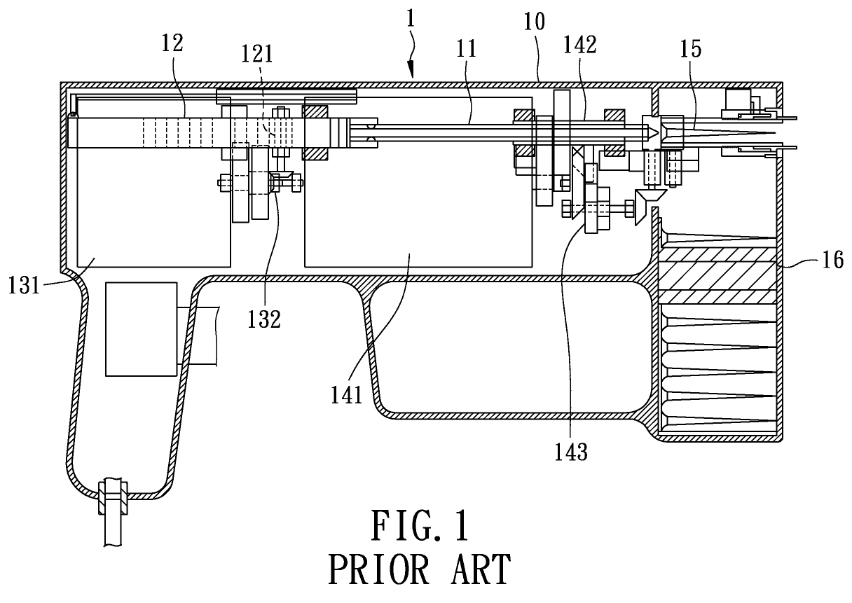

FIG. 2 is a sectional view of the preferred embodiment of an automated screw driving device according to the present invention;

FIG. 3 is an exploded perspective view of the preferred embodiment;

FIG. 4 is an assembled perspective view of the preferred embodiment, viewed from one side of the preferred embodiment;

FIG. 5 is another assembled perspective view of the preferred embodiment, viewed from an opposite side of the preferred embodiment;

FIG. 6 is a sectional view taken along lines VI-VI of FIG. 2, illustrating a state in which a wheel-contacting member of a carrier is spaced apart from a fly wheel by a gap;

FIG. 7 is a schematic side view of the preferred embodiment;

FIG. 8 is a sectional view of the preferred embodiment illustrating a state in which a screwdriver together with the carrier is driven by the flywheel to move and to deliver an impact to a screw; and

FIG. 9 is a sectional view taken along lines IX-IX of FIG. 8, illustrating a state in which the wheel-contacting member contacts the fly wheel.

### DETAILED DESCRIPTION OF THE PREFERRED EMBODIMENT

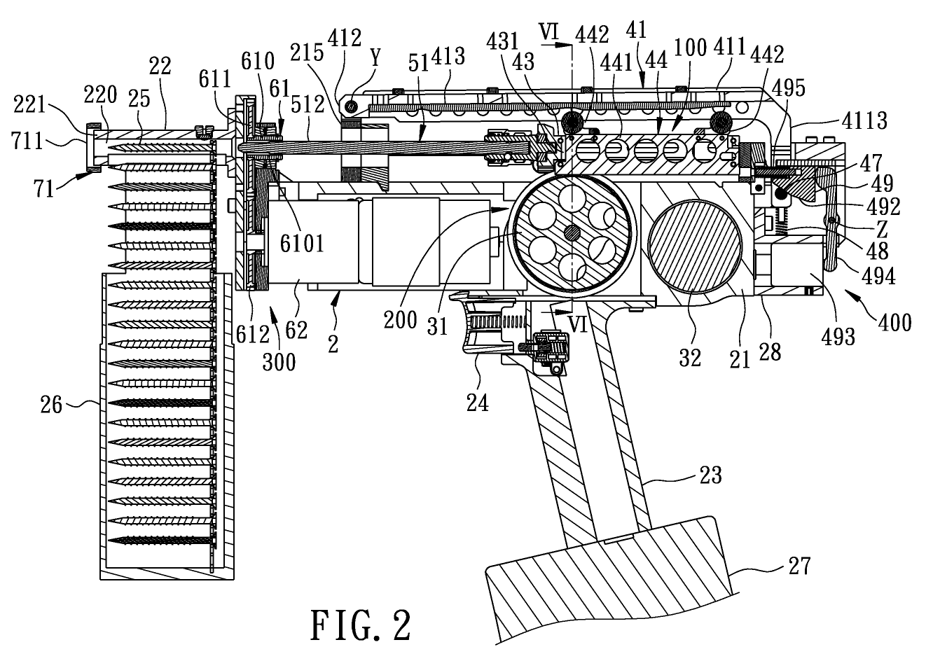

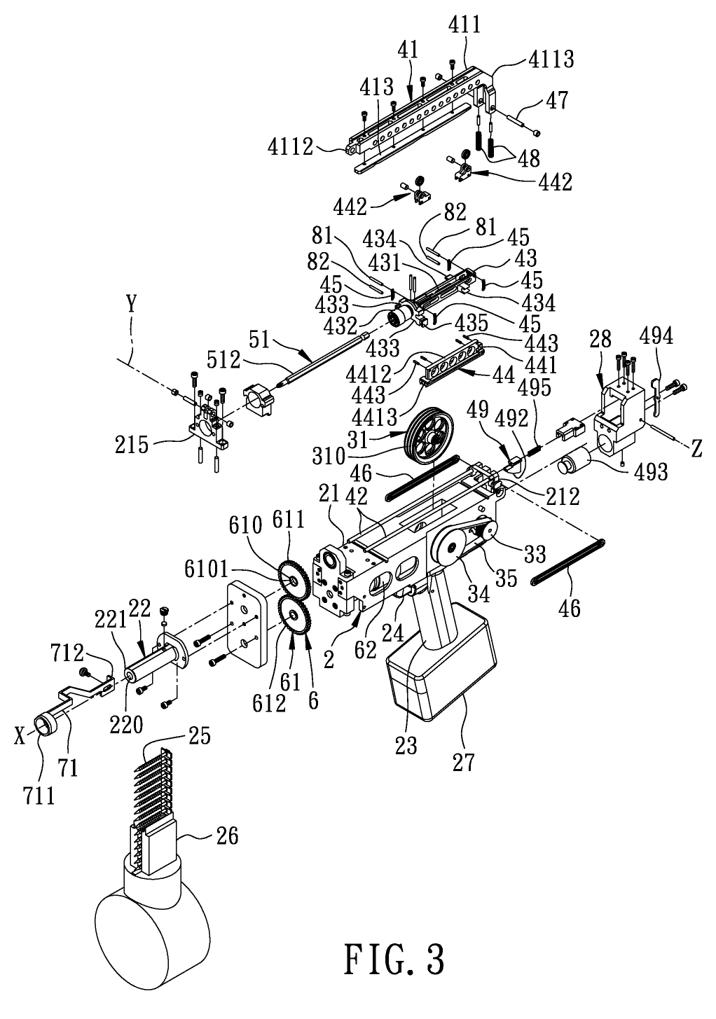

FIGS. 2 to 5 illustrate the preferred embodiment of an automated screw driving device according to the present invention. The automated screw driving device includes: a gun housing 2 defining a screw passage 220 that extends in an axial direction (X) ; a screw magazine 26 receiving a plurality of screws 25 therein and operable to feed a topmost one of the screws 25 into the screw passage 220; a carrier 100 mounted slidably on the gun housing 2 for moving in the axial direction (X) ; a screwdriver 51 carried by the carrier 100 to move in the axial direction (X) for hitting and driving the screw 25 in the screw passage 220 into an object (not shown); a carrier-driving unit 200 (see FIG. 2) for driving sliding movement of the carrier 100 in the axial direction (X) ; a rotation-driving unit 300 for driving rotation of the screw driver 51 about its axis that is parallel to the axial direction (X); a contact-controlling unit 400 for controlling an interaction between the carrier 100 and the carrier-driving unit 200; a safety mechanism; and a control circuit (not shown).

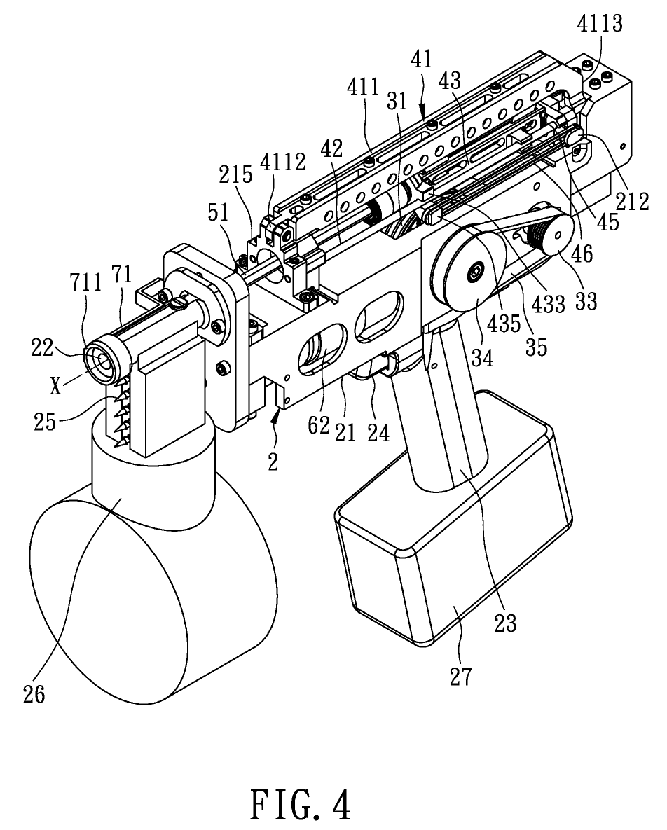

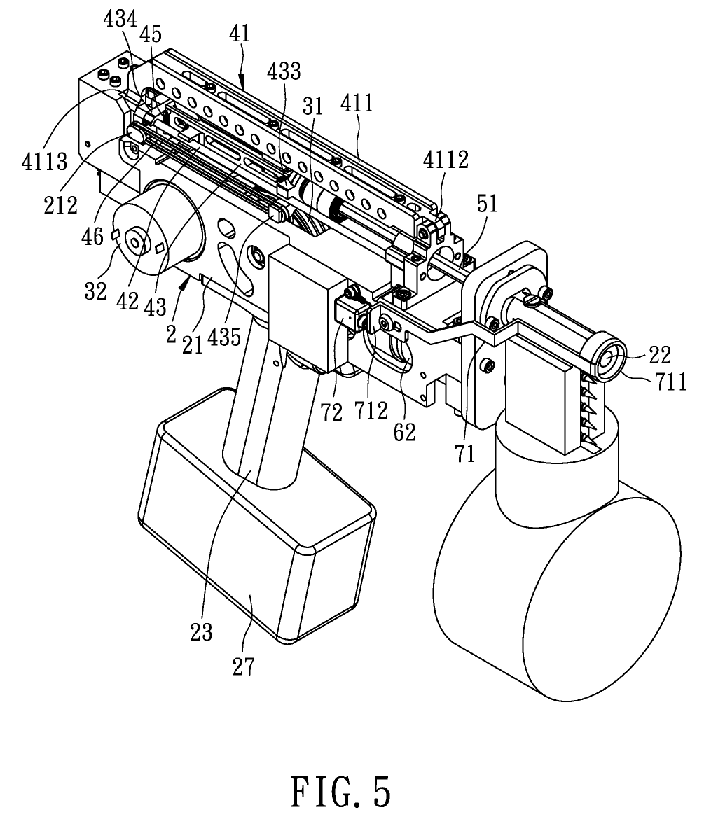

The gun housing 2 has a main body 21, a gun barrel 22 secured to and extending frontwardly from a front end of the main body 21, a control seat 28 extending rearwardly from a rear end of the main body 21, and a handle 23 extending downwardly from a bottom of the main body 21. A trigger 24 is mounted movably to the main body 21. A battery housing 27 is connected to a bottom of the handle 23 for receiving batteries (not shown) therein. The gun barrel 22 confines the screw passage 220, and has a front open end 221. The screw magazine 26 is connected to the gun barrel 22. A pair of guiding rods 42 are mounted on a top end of the main body 21. The rear end of the main body 21 is formed with two opposite first hooks 212 (which are respectively shown in FIGS. 4 and 5). A pivot seat 215 is secured to the top end of the gun housing 2.

The carrier 100 includes a slider member 43, a wheel-contacting member 44, and a plurality of spring members 45. The slider member 43 has a rectangular frame body 431, a bearing sleeve 432 extending from a front end of the rectangular frame body 431, two front C-shaped protrusions 433 protruding from two opposite sides of the rectangular frame body 431, and two rear C-shaped protrusions 434 protruding from the two opposite sides of the rectangular frame body 431. Each of the two front C-shaped protrusions 433 is formed with a second hook 435 (see FIGS. 4 and 5). The front and rear C-shaped protrusions 433, 434 respectively engage the guiding rods 42 so as to permit sliding movement of the slider member 43 on the guiding rods 42.

The wheel-contacting member 44 has a contact block 441 and a pair of casters 442. The contact block 441 has an upper portion 4412 and a lower portion with a corrugated bottom surface 4413. The casters 442 are secured to the upper portion 4412 of the contact block 441 through fasteners 443. The upper portion 4412 of the contact block 441 extends into the rectangular frame body 431. Two upper connecting pins 81 extend through a top end of the rectangular frame body 431. Two lower connecting pins 82 extend through the lower portion of the contact block 441. Each of the spring members 45 interconnects a respective one of the upper connecting pins 81 and a respective one of the lower connecting pins 82 so that the wheel-contacting member 44 can be movably mounted to the slider member 43, and be moved downward relative to the slider member 43 against the urging action of the spring members 45 when the wheel-contacting member 44 is pushed downward. The screw driver 51 has a rear end that is journalled in the bearing sleeve 432 of the slider member 43.

The carrier-driving unit 200 is mounted to the gun housing 2, and includes a fly wheel 31, a first motor 32, a driving pulley 33 driven by the first motor 32, a driven pulley 34 connected to the fly wheel 31, and a belt 35 interconnecting the driving pulley 33 and the driven pulley 34. The fly wheel 31 is driven by the first motor 32 to rotate relative to the gun housing 2 about its axis, and has an annular corrugated surface 310.

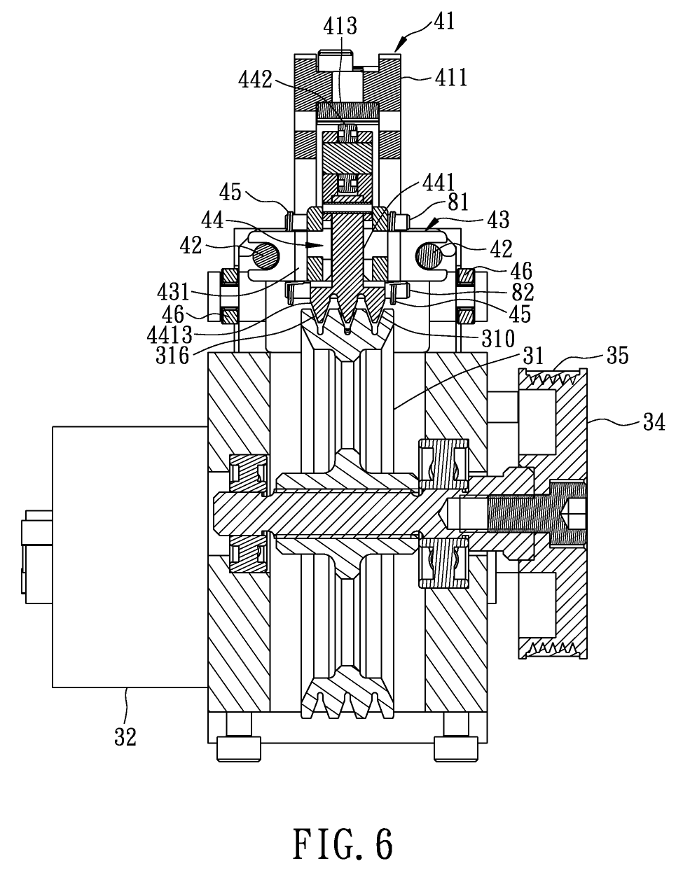

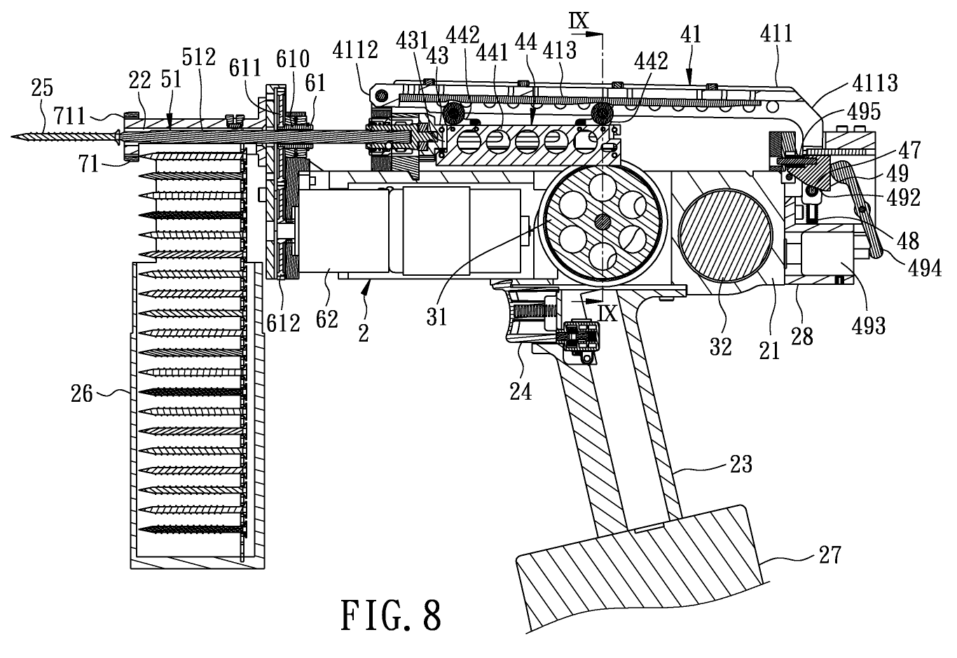

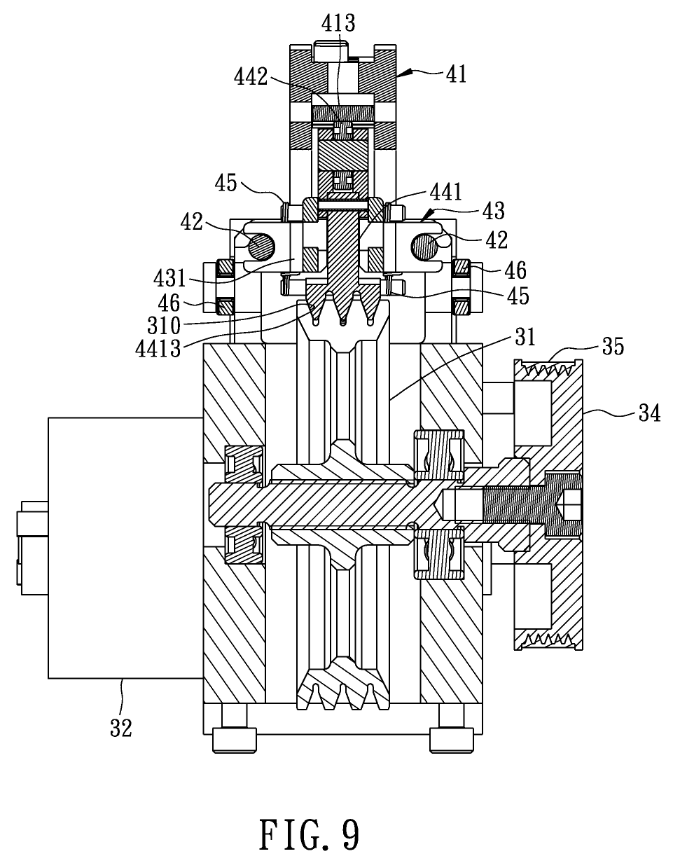

The wheel-contacting member 44 is movable relative to the slider member 43 toward the fly wheel 31 from an upper position (see FIGS. 2 and 6) to a lower position (see FIGS. 8 and 9) to contact frictionally the fly wheel 31 so as to generate a frictional force therebetween and to permit the power of the first motor 32 to be transferred to the carrier 100 to cause rapid sliding movement of the carrier 100 relative to the gun housing 2 toward the screw passage 220 upon rotation of the fly wheel 31 about its axis. In this embodiment, the corrugated bottom surface 4413 of the contact block 441 is spaced apart from the annular corrugated surface 310 of the fly wheel 31 by a gap 316 (see FIG. 6) when the wheel-contacting member 44 is disposed at the upper position, and is in frictional contact with the annular corrugated surface 310 of the flywheel 31 (see FIG. 9) when the wheel-contacting member 44 is disposed at the lower position. Note that the gap 316 disappears when the wheel-contacting member 44 is disposed at the lower position.

Two coiled resilient restoring members 46 interconnect the slider member 43 and the gun housing 2. In this embodiment, each of the resilient restoring members 46 is hooked on a respective one of the first hooks 212 and a respective one of the second hooks 435 of the front C-shaped protrusions 433 (see FIGS. 4 and 5) so that when the carrier 100 is driven by the fly wheel 31 through the wheel-contacting member 44 to slide against the urging action of the resilient restoring members 46 toward the screw passage 220, the resilient restoring members 46 can accumulate a restoring force to move the carrier 100 away from the screw passage 220 to its original position when the fly wheel 31 stops rotating about its axis.

The rotation-driving unit 300 includes a gear set 61 and a second motor 62. The gear set 61 includes a driving gear 612 coupled to the second motor 62, a driven gear 611 engaging the driving gear 612, and an inner sleeve 610 secured to the driven gear 611 and defining a non-circular hole 6101 therein. The screw driver 51 has a non-circular portion 512 extending through and engaging the non-circular hole 6101 (see FIG. 8) so as to permit the screw driver 51 to be coupled to the gear set 61 and to be rotated by the driven gear 611 upon actuation of the second motor 62.

The contact-controlling unit 400 includes a pressing member 41, a cam 49, a cam follower 47, a cam-driving member, a first biasing member 495 for urging the cam 49, and two second biasing members 48 for urging the pressing member 41 together with the cam follower 47.

The pressing member 41 has a pressing arm 411 and a guiding rail 413 that is mounted to the pressing arm 411. The pressing arm 411 has a pivot end 4112 that is pivoted to the gun housing 2 through the pivot seat 215 so as to be rotatable about a first axis (Y) relative to the gun housing 2, and a driven end 4113 that is disposed opposite to the pivot end 4112. The wheel-contacting member 44 is driven by the pressing member 41 against the urging action of the spring members 45 to move relative to the slider member 43 toward the fly wheel 31. The spring members 45 urge the wheel-contacting member 44 to move relative to the slider member 43 away from the fly wheel 31 to its original position when the wheel-contacting member 44 is released from the pressing member 41. The casters 442 are disposed under the guiding rail 413. The guiding rail 413 is in sliding contact with and presses against at least one of the casters 442 when the pressing member 41 is rotated from a first angular position (see FIG. 2) to a second angular position (see FIG. 8).

The cam follower 47 is secured to the driven end 4113 of the pressing arm 411. The cam 49 is mounted movably on the gun housing 2, and has a curved surface 492 that abuts against the cam follower 47.

The cam-driving member includes a solenoid valve 493 that is mounted to the control seat 28 of the gun housing 2 and that is controlled by the trigger 24, and a lever 494 that is pivoted to the control seat 28 of the gun housing 2 and that abuts against the cam 49. The lever 494 of the cam-driving member drives the cam 49 to move frontwardly against the urging action of the first biasing member 495 so as to drive rotation of the cam follower 47 together with the pressing arm 41 about the first axis (Y) against the urging action of the second biasing members 48.

The solenoid valve 493 is triggered by the trigger 24 to drive rotation of the lever 494 relative to the gun housing 2 about a second axis (Z) so as to push the cam 49 to move frontwardly against the urging action of the first biasing member 495.

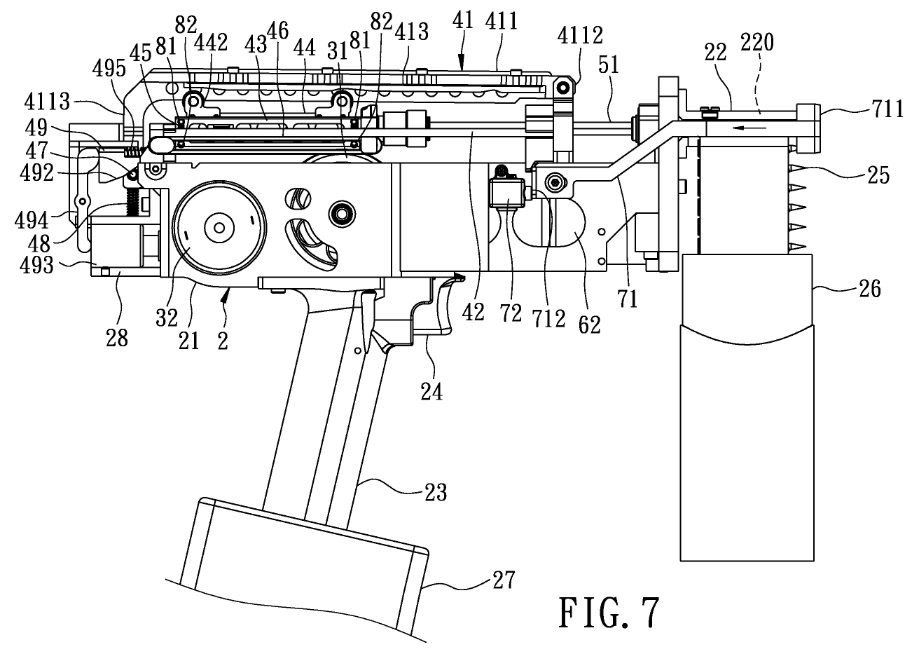

The safety mechanism includes a safety member 71 and a photo sensor 72. The safety member 71 is movably mounted to the gun barrel 22, and has front and rear ends 711, 712. The front end 711 of the safety member 71 is disposed frontwardly of the front open end 221 of the gun barrel 22. The photo sensor 72 is mounted to the gun housing 2, and is operatively associated with the first motor 32 for actuating the first motor 32. The safety member 71 is movable relative to the gun housing 2 in a rearward direction so as to move the rear end 712 of the safety member 71 toward the photo sensor 72 in order to actuate the first motor through the photo sensor 72 (see FIG. 7).

In operation, the safety member 71 is brought into contact with and presses against the object (not shown) by a user so as to enable the photo sensor 72 and the first motor 32 to drive rotation of the fly wheel 31, and the trigger 24 is subsequently pulled by the user so as to actuate the solenoid valve 493 to drive movement of the cam 49 through the lever 494, which, in turn, drives rotation of the cam follower 47 together with the pressing member 41 about the first axis (Y). The pressing member 41 is rotatable to push and move the wheel-contacting member 44 relative to the slider member 43 toward the fly wheel 31, thereby resulting in frictional contact between the wheel-contacting member 44 and the fly wheel 31, which, in turn, causes rapid sliding movement of the carrier 100 together with the screwdriver 51 toward the screw passage 220 and hitting of the screw 25 by the screw driver 51. With a high rotational speed of the fly wheel 31, a considerably large thrust force can be created and be transferred to the screw driver 51, thereby rendering the screw driver 51 to move at a relatively high speed to hit hard the screw 25, which permits fast movement and penetration of the screw 25 into the object. In addition, the control circuit presets a predetermined waiting time at the time that the solenoid valve 493 is actuated, and automatically actuates the second motor 62 immediately after the predetermined waiting time has elapsed so as to drive rotation of the screw driver 51 through the gear set 61 to advance the screw 25 into the object. When the operation of driving the screw 25 is finished, the user removes the safety member 71 away from the object and releases the trigger 24, thereby deactivating the first and second motors 32, 62 and the solenoid valve 493 and permitting restoration of the pressing member 41 together with the cam follower 47 and the carrier 100 together with the screw driver 51 to their original positions by the urging actions of the second biasing members 48 and the resilient restoring members 46, respectively.

With the inclusion of the carrier 100, the carrier-driving unit 200 and the contact controlling unit 400 in the automated screw driving device of this invention, the screw driver 51 can be moved toward the screw passage 220 at a high speed, thereby overcoming the aforesaid drawback associated with the prior.

While the present invention has been described in connection with what is considered the most practical and preferred embodiment, it is understood that this invention is not limited to the disclosed embodiment but is intended to cover various arrangements included within the spirit and scope of the broadest interpretation and equivalent arrangements.

What is claimed is:

1. An automated screw driving device comprising:
a gun housing defining a screw passage that is adapted to receive a screw therein;
a first motor mounted to said gun housing;
a fly wheel mounted to said gun housing and driven by said first motor to rotate relative to said gun housing about its axis;
a carrier mounted slidably on said gun housing and having a wheel-contacting member that is movable toward said flywheel to contact frictionally said flywheel so as to permit the power of said first motor to be transferred to said carrier to cause rapid sliding movement of said carrier relative to said gun housing toward said screw passage upon rotation of said fly wheel about its axis;
a screw driver mounted rotatably to said carrier so as to be carried by said carrier to hit the screw in said screw passage upon rapid sliding movement of said carrier;
a gear set coupled to said screw driver; and
a second motor coupled to said gear set for driving rotation of said screw driver relative to said carrier.

2. The automated screw driving device of claim 1, further comprising a contact-controlling unit that includes a pressing member, the pressing member being pivoted to said gun housing and being rotatable about a first axis relative to said gun housing to drive movement of said wheel-contacting member toward said fly wheel.

3. The automated screw driving device of claim 2, wherein said carrier further has a slider member mounted slidably on said gun housing, and at least one spring member interconnecting said slider member and said wheel-contacting member so as to permit said wheel-contacting member to be mounted movably on said slider member, said wheel-contacting member being driven by said pressing member against the urging action of said spring member to move relative to said slider member toward said fly wheel, said spring member urging said wheel-contacting member to move relative to said slider member away from said fly wheel to its original position when said wheel-contacting member is released from said pressing member.

4. The automated screw driving device of claim 3, further comprising a resilient restoring member interconnecting said slider member and said gun housing, said carrier being driven by said fly wheel through said wheel-contacting member to slide against the urging action of said resilient restoring member toward said screw passage, said resilient restoring member urging said carrier to move away from said screw passage to its original position when said fly wheel stops rotating about its axis.

5. The automated screw driving device of claim 4, wherein said pressing member has a pressing arm that is pivoted to said gun housing, and a guiding rail that is mounted to said arm, said wheel-contacting member having a contact block and at least one caster, said fly wheel having an annular corrugated surface, said contact block having a top end and a corrugated bottom surface, said corrugated bottom surface being in frictional contact with said annular corrugated surface of said fly wheel when said wheel-contacting member is disposed at a lower position, and being spaced apart from said annular corrugated surface of said fly wheel by a gap when said wheel-contacting member is disposed at an upper position, said caster being secured to said top end of said contact block and being disposed below said guiding rail, said guiding rail being in sliding contact with and pressing against said caster when said pressing member is rotated from a first angular position to a second angular position.

6. The automated screw driving device of claim 2, wherein said contact-controlling unit further includes a cam, a cam follower, a cam-driving member, and first and second biasing members for urging said cam and said cam follower, respectively, said pressing member having a pressing arm that has a pivot end pivoted to said gun housing, and a driven end that is disposed opposite to said pivot end, said cam follower being secured to said driven end of said pressing arm, said cam being mounted movably on said gun housing and having a curved surface that abuts against said cam follower, said cam-driving member driving said cam to move against the urging action of said first biasing member so as to drive rotation of said cam follower together with said pressing arm about the first axis against the urging action of said second biasing member.

7. The automated screw driving device of claim 6, wherein said gun housing is provided with a trigger, said cam-driving member including a valve mounted to said gun housing and controlled by said trigger, and a lever pivoted to said gun housing and abutting against said cam, said valve being triggered by said trigger to drive rotation of said lever relative to said gun housing about a second axis so as to push said cam to move against the urging action of said first biasing member.

8. The automated screw driving device of claim 1, further comprising a safety member and a photo sensor, said gun housing having a gun barrel that confines said screw passage, said gun barrel having a front open end, said safety member being movably mounted to said gun barrel and having front and rear ends, said front end of said safety member being disposed frontwardly of said front open end of said gun barrel, said photo sensor being mounted to said gun housing and being operatively associated with said first motor for actuating said first motor, said safety member being movable relative to said gun housing so as to move said rear end of said safety member toward said photo sensor in order to actuate said first motor through said photo sensor.

9. The automated screw driving device of claim 1, wherein said gear set includes a driving gear coupled to said second motor, a driven gear engaging said driving gear, and an inner sleeve secured to said driven gear and defining a non-circular hole therein, said screw driver having a non-circular portion extending through and engaging said non-circular hole so as to be rotated by said driven gear upon actuation of said second motor.
